(19) United States
(12) Patent Application Publication
(10) Pub. No.: US 2011/0088627 A1
(43) Pub. Date: Apr. 21, 2011

(54) INTEGRAL CONTROL BOX, SPINNER AND FUNNEL UNIT WITH ADJUSTABLE LEGS

(75) Inventor: Burnell Gates, San Antonio, TX (US)

(73) Assignee: ALL SEASONS FEEDERS, INC.

(21) Appl. No.: 12/907,381

(22) Filed: Oct. 19, 2010

Related U.S. Application Data
(60) Provisional application No. 61/253,368, filed on Oct. 20, 2009.
(60) Provisional application No. 61/290,301, filed on Dec. 28, 2009.

(51) Int. Cl. A01K 5/02; A01K 5/00

(52) U.S. Cl. 119/57.1; 119/57.91; 119/63

(57) ABSTRACT

A wildlife feeder with a control box assembly for engaging a bottom wall of a hopper of a wildlife feeder is provided, the bottom wall having a hopper feed dispensing opening. The hopper is supported on a multiplicity of legs above the ground. The assembly includes a motor with a drive shaft, and a spinner mounted near a removed end of the drive shaft. A control box having a control box housing is provided with an upper wall, the upper wall having an opening to allow the drive shaft to project substantially vertically therethrough. A hopper engagement plate is provided for engaging the bottom wall of the hopper adjacent the hopper feed dispensing opening. The hopper engagement plate has a base with a feed opening therethrough. The hopper engagement plate has walls with a multiplicity of legs depending therefrom. The feed opening of the base is located substantially below the hopper feed dispensing opening.

This utility patent application claims the benefit of and incorporates herein by reference U.S. Provisional Patent Application Ser. No. 61/253,368, filed Oct. 20, 2009; and U.S. Provisional Patent Application Ser. No. 61/290,301, filed Dec. 28, 2009.

### FIELD OF THE INVENTION

Wildlife feeders, more specifically, control boxes and spinner plate assemblies for use with wildlife feeders.

### BACKGROUND

Integral control box and spinner assemblies are known for use with wildlife feeders. These prior art control box/spinner assemblies are typically designed to depend from the bottom of a leg mounted hopper of a wildlife feeder. The hoppers usually stand at least several feet above the ground on three or four legs. They channel the particulate feed contained therein to an opening, typically centrally located at the bottom of the hopper. Prior art control box/spinner plate assemblies are then typically mounted below the centrally located opening of the hopper on a pair of hopper mounted legs. The pair of legs are slotted and receive fixed fasteners protruding from opposite sides of the housing of the control box portion of the assembly. Wing nuts are used in conjunction with the fasteners, which are received through the slots to allow for adjustable placement of the control box/spinner plate assembly below the opening of the hopper.

The prior art assemblies typically include a control box, which has a typically rectangular exterior housing, and a motor with a drive shaft. The motor is typically centrally located within the housing of the assembly with the shaft protruding upward through the top wall of the housing. The motor drive shaft receives a hub onto which a spinner plate is mounted. The housing of the control box typically includes a DC battery, sometimes with a small solar panel remotely located and engaged therewith. The DC battery powers the electric motor. The control is by a control panel which allows the user to set the time and duration of the spinner activation.

The bottom portion of the hoppers may be flat or canted at an angle (that is, an inverted truncated cone or a multi-sided tapering bottom). Whatever the shape of the bottom, be it a combination of flat and angled, angled or all flat, there is an opening or hole centrally located from which the particulate feed can flow. Placement of the spinner plate is typically directly below such opening. Occasionally a seed funnel is provided for engaging the opening, which feed funnel includes a base and a mouth portion, the mouth portion depending from the base. The funnel base typically has a rim that is larger in diameter than the opening at the bottom of the hopper and the mouth depending below the base is smaller diameter than the hopper opening. Thus, there is easy placement of the funnel with the rim inside the bottom opening (for support), but the mouth extending through the bottom opening of the hopper and directing feed more accurately to the spinner plate of the control box/spinner plate unit.

Turning now to the prior art, in spinner plate control box and hopper wildlife feed assemblies and units, certain drawbacks have been observed. One drawback is the instability of the present prior art control box/spinner plate assemblies, wherein a pair of legs is provided for adjustably locating the assembly vertically below the hopper bottom opening. While this pair of legs may be sufficiently durable for the use as intended, Applicant has found that in transporting a hopper with a control box/spinner plate assembly attached thereto, especially when the hopper is laid with its normally vertical axis horizontally, for example, in a trailer or in the back of a pickup truck, the weight of the assembly can cause the legs to bend.

Another shortcoming of the prior art is that it leaves the spinner plate accessible to varmints, birds, raccoons and similar critters that attempt to steal the food off the plate. This exposure of the plate is sometimes due, in part, to the prior art means of engaging the legs of the assembly to the bottom of the hopper and in part due to the dimensions of the prior art. With regard to the dimensions, it is observed that the prior art provides no means for structural and functional advantages that allow a very small gap in which the spinning plate can operate.

### OBJECTS OF THE INVENTION

It is an object of the present invention to overcome the shortcomings of prior art wildlife feed assemblies, more particularly, shortcomings of wildlife feed units wherein a control box/spinner assembly is located below the hopper to receive feed therefrom.

It is a more particular object of the present invention to provide for a strong, stable mounting of a control box/spinner assembly to a hopper and further a mounting which is capable of limiting the accessibility of the spinner plate and the feed thereon from varmints, critters, and the like.

### SUMMARY OF THE INVENTION

In an effort to overcome the aforementioned limitations and other shortcomings of the prior art, Applicant has provided for a hopper engagement plate to be engaged to the bottom of the hopper. The hopper engagement plate in turn contains legs, typically four which depend therefrom, from which the control box/spinner assembly is adjustably hung or suspended. That is to say, instead of attaching legs to the underside of the hopper, the legs depend from a hopper engagement plate, which is fastened by any conventional means, to the bottom of the hopper. This plate is dimensioned substantially identical to or even larger than the top wall of the housing of the control box and is at least in part tabular or flat in nature. Thus, adjustment of the control box/spinner assembly is made with respect to the plate and, further, the adjustment legs, slots, hub and the like are adapted to provide for small gaps between the hopper engaging plate and the top surface of the control box.

This gap is sufficient for the spinner plate location and operation but also is small enough to prevent access by critters to the spinner plate (which may have feed on it) or the feed opening. The small gaps and the specific dimensions, as well as the geometry of the flat base and flat top to the control box housing, make for difficult access of varmints attempting to reach the control plate.

A wildlife feeder comprising a hopper having an engagement plate, the engagement plate including a tabular, flat, generally horizontal base and having a feed opening therein; a spinner; and a control box having a control box housing having an upper wall and a motor, the motor with a drive shaft, the spinner mounted to the end of the drive shaft and centered below the feed opening of the base; wherein the upper wall of the control box is aligned below and spaced apart from the base of the engagement plate so as to generally eliminate varmint access thereto.

### BRIEF DESCRIPTION OF THE DRAWINGS

FIG. 1 illustrates the combination unit 10 exploded away from the bottom of a hopper H showing the placement of the unit to the hopper and the location of the funnel (optional); FIGS. 1 and 2-8 all featuring a first embodiment of a hopper engagement plate 14.

FIGS. 1A, 1B, and 1D illustrate an embodiment of Applicant's combination unit that has a second embodiment of a hopper engagement plate 16 and which drawings also feature further details and elements common to the combination unit regardless of whether it includes the first or the second embodiment of the hopper engagement plate, including elements of the spinner plate and its location and construction. FIG. 1A is a perspective view; FIG. 1B is a top elevational view; and FIG. 1D is an exploded elevational view of the unit.

FIG. 1C is an exploded perspective view of the unit with the first embodiment of the hopper engagement plate 14 illustrated.

FIG. 2 is a perspective view from the side of the unit.

FIG. 3 is a side elevational view of the unit.

FIG. 4 is a side elevational view of the unit (rotated from FIG. 3); and FIG. 4A is a close-up showing some of the dimensions of the gap between the base plate of the hopper engagement plate 14/16, and the spinner plate and the top of the control box housing located below the spinner plate.

FIG. 5 is a side perspective view of the combination unit cut away to show the controller, motor, and battery.

FIG. 6 is a side elevational view cutaway to show the motor and battery of the combination unit.

FIG. 7 is a top elevational view of the unit showing the spinner plate through the central opening of the base of the hopper engagement plate 14.

FIG. 8 is a perspective view of the underside of the unit.

FIG. 9 is an exploded view of a alternate preferred embodiment of the combination unit.

FIG. 10 is an perspective view of an alternate preferred embodiment of the combination unit.

FIG. 11 is a side elevational view of an embodiment of Applicant's device as set forth herein wherein the hopper has an engagement plate incorporated therewith.

### DETAILED DESCRIPTION OF THE PREFERRED EMBODIMENTS

With reference to the attached Figures, it is seen that Applicant provides a combination unit 10, which combination unit 10 includes a control box/spinner plate assembly 12 (similar in some regards to prior art), which is adjustably engaged to a novel hopper engagement plate 14/16. A first embodiment of the hopper engagement plate is identified with the numeral 14 and a second embodiment identified with the numeral 16.

A funnel 18 may be used, optionally, to engage a bottom opening HO in a hopper H in ways known in the art. Hopper H is seen to contain feed F, typically particulate corn or the like, and hopper may have a bottom wall or underside HU.

Turning now to hopper engagement plate 14, it is seen that, like hopper engagement plate 16, when engaged to the bottom of a hopper, regardless of the shape of the bottom of the hopper, hopper engagement plate 14/16 will have a base that will lay in a horizontal plane and will typically substantially mirror the shape and dimensions of the top surface of the control box 40 of the control box spinner assembly 12.

It is seen that embodiment of the hopper engagement plate 14 has four flanges 20 and four side walls 22 depending therefrom. The flanges may be used or fashioned to engage the hopper underside HU, as by fasteners, welding or other means. The side walls engage a tabular rectangular (or other suitable shape) horizontal base 24, which has a feed opening 24A, typically centrally located, therein. Feed opening 24A is interposed below the feed opening or hopper opening HO of the hopper. That is to say, hopper engagement plate 14 has flanges which are attached to the hopper underside HU with side walls depending thereof, which will typically place the base 24 below and in a spaced apart relation to the hopper underside, and which places feed opening 24A below a feed opening HO in the hopper. Feed opening HO of hopper may, optionally, include a funnel 18.

Under the impetus of gravity, particulate feed will flow out of hopper opening HO and/or through a funnel, if used, and be directed through feed opening 24A. Moreover, it is seen that feed opening 24A will be centrally located over spinner plate 42 of control box/spinner plate assembly 12. Further, it seen that hopper engagement plate 14 has typically four legs depending therefrom, typically two on either side spaced apart, with the legs having captive slots 28 in the lower portion thereof.

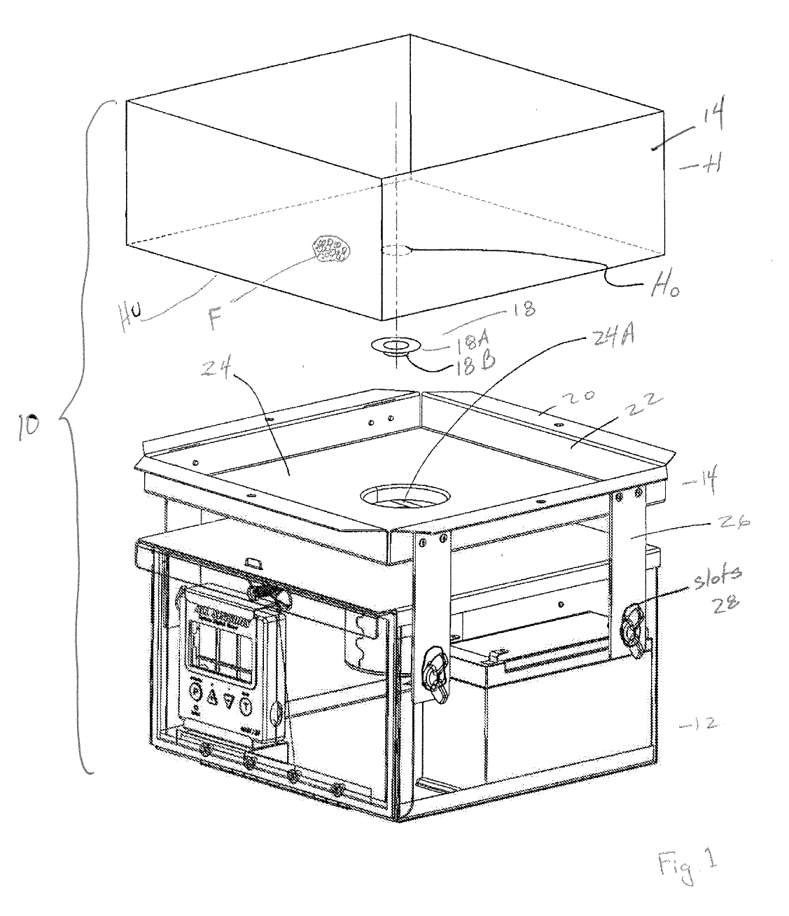

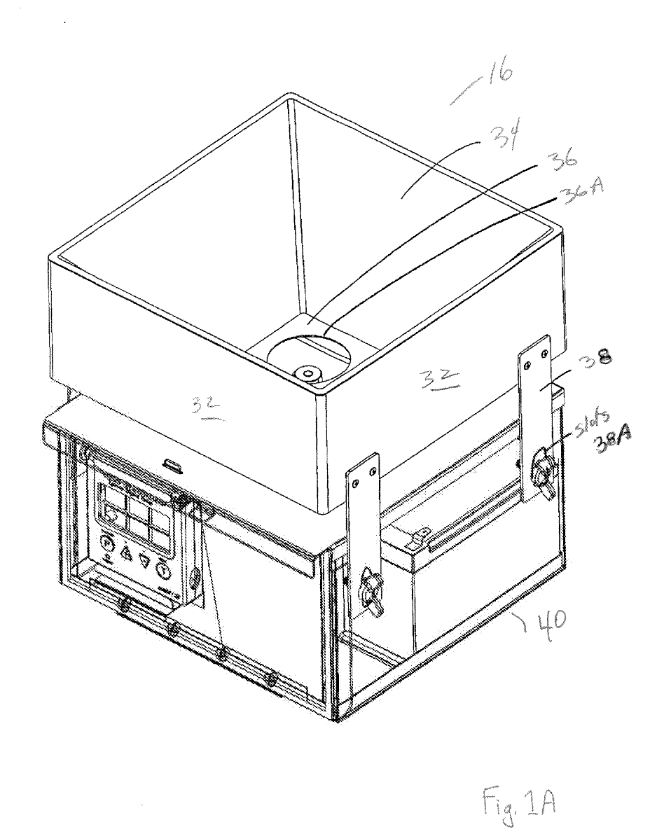

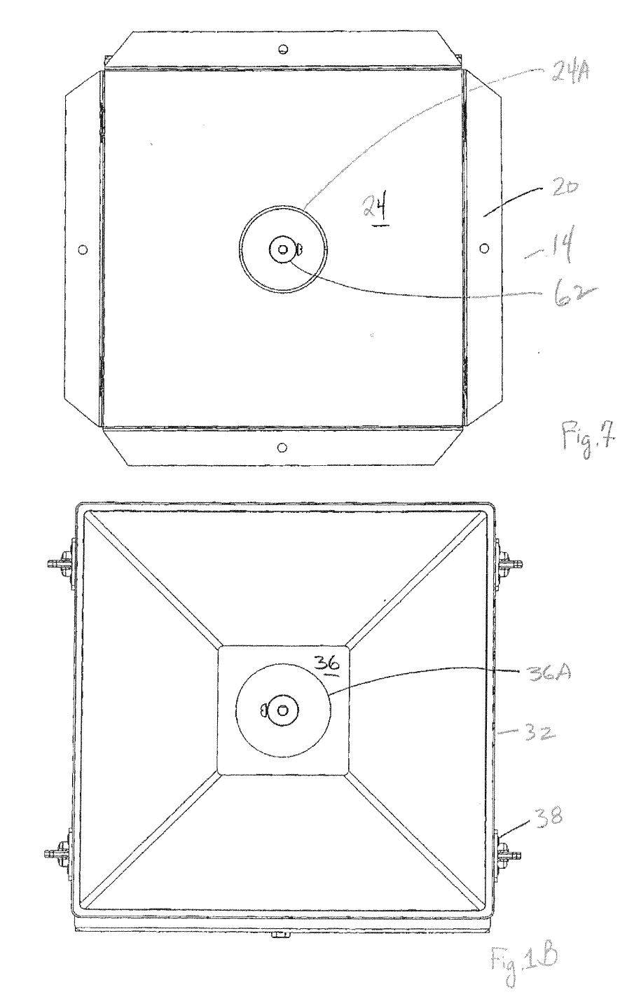

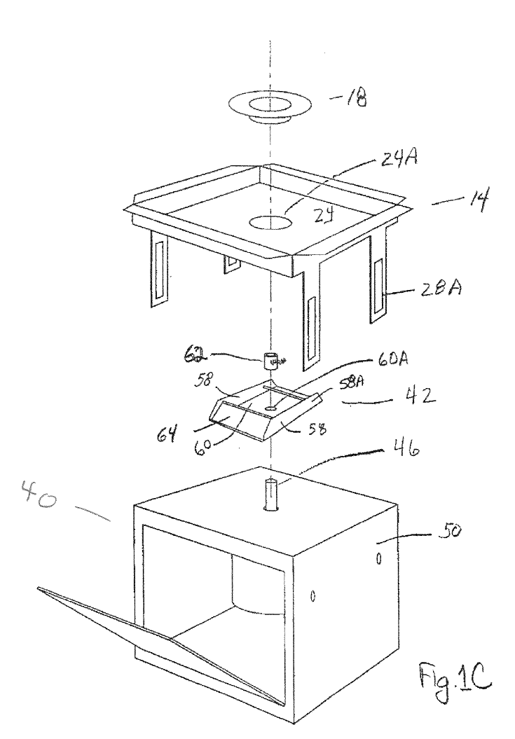

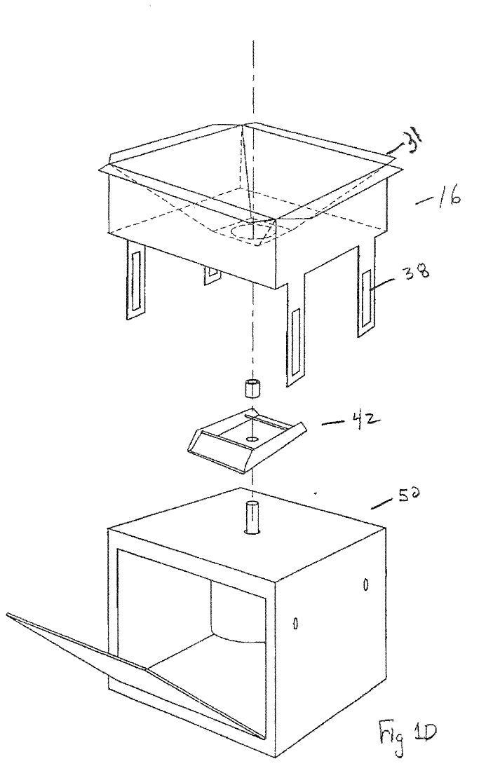

Turning now to a second embodiment of hopper engagement plate 16 (see FIGS. 1A 1B, and 1D), there is seen to be four outer side walls 32 which are typically vertically aligned when the unit is in place on the hopper. There are seen to be four flanges 31 attached to upper perimeter of the side walls 32 and projecting therefrom for assisting in attaching the plate 16 to the underside of the hopper HU by using fasteners, welding or other ways. Flanges 30/31 of either embodiment may be bent to conform to a sloping hopper underside. There are seen to be tapered inner side walls 34, again typically four, which are tapered to a flat, typically horizontal base 36 having a feed opening 36A therein, analogous to feed opening 24A of base 24 of the first embodiment designated with element 14. The base will typically provide full, flat coverage of the hopper support plate 16, typically joining the lower perimeter of the four outer side walls 32. Four legs are typically provided designated with element 38, which four legs are spaced apart for engaging opposite sides of control box housing 50 as indicated in the Figures. At the lower end of legs 38 are captive slots 38A, which receive fasteners mounted to the housing of the control box in ways known in the art.

Control box/spinner assembly 12 is adapted to engage either embodiment of hopper engagement plates 14/16. Control box spinner assembly is seen to include a control box 40 and a spinner plate 42. The control box typically includes a motor 44 with a motor shaft 46 extending perpendicularly upward through control box housing 50 in ways known in the art. A controller 48 and battery 49 is provided.

Control box 40 typically includes a control box housing 50 housing the motor, controller, battery, and other assorted elements some of which are known to the prior art. Control box housing 50 is seen to be generally rectangular and having four tabular side walls 52, a tabular bottom wall 54, and a tabular top wall 56. Moreover, it is seen that the top wall 56 has a centrally located opening for the vertical extension of motor shaft 46 outward therefrom, the motor shaft being adapted to receive spinner plate 42.

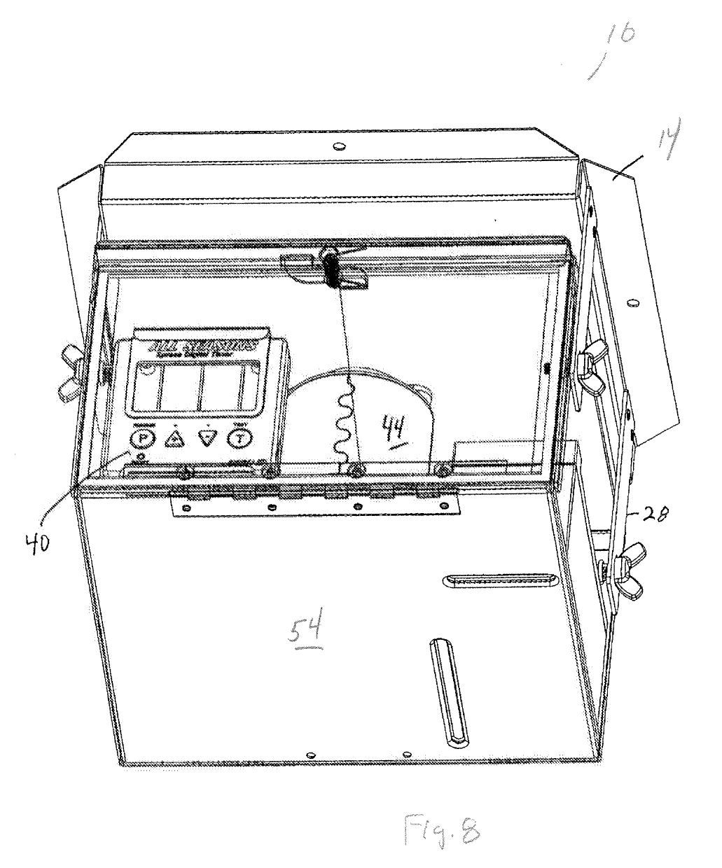

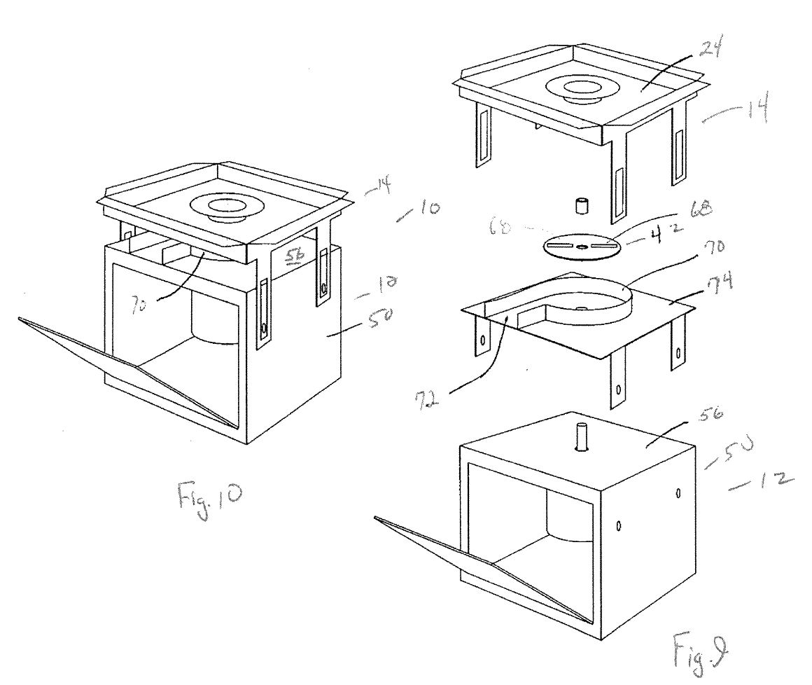

Spinner plate 42 may take a variety of shapes as illustrated in FIGS. 9 and 10, showing a round spinner plate with radial members 68. The embodiment of the spinner plate 42 illustrated in FIGS. 9 and 10 is used in conjunction with a directional barrier 70. Directional barrier 70 typically substantially surrounds spinner plate 42 (of any shape), except has a mouth 72 which will help propel the particulate feed matter falling thereon into a specific direction. Radial members 68 are typically upstanding or projecting vertically above the flat base of spinner plate 42 and helps sweep the particulate feed around the perimeter of the directional member 70 until the feed gets to the mouth where it can be thrown out under the spinning action of the spinner plate 42. Directional members are typically used with a round plate and has a circumference typically slightly larger than the circumference of the round plate, excepting of course at the mouth 72. In FIG. 9, it is seen that directional member 70 is mounted to an intermediate plate 74, which intermediate plate is mounted on legs to the control box/spinner plate assembly 12. In FIG. 10, it is seen that directional member 70 may be mounted directly to top wall 56 of control box housing 50 or, in the alternative (not shown), directional member 70 may be attached to the underside of base 24.

Spinner plate 42 is seen to include a pair of parallel spaced apart side walls 52 engaging at the bottom edge thereof, a tabular or flat bottom wall 60. Bottom wall 60 has a centrally located shaft opening 60A for receipt of motor shaft 46 therethrough. A hub 62 may be pressed fit to bottom wall 60 and is adapted to be located substantially on the top side of bottom wall 60 and is threaded to receive a fastener for engagement of the hub (and therefore the spinner plate 42) to the motor shaft, so as to rotate when the motor 44 is energized. A pair of pivot flaps 64 are provided at the mouths 65 of the spinner plate 42.

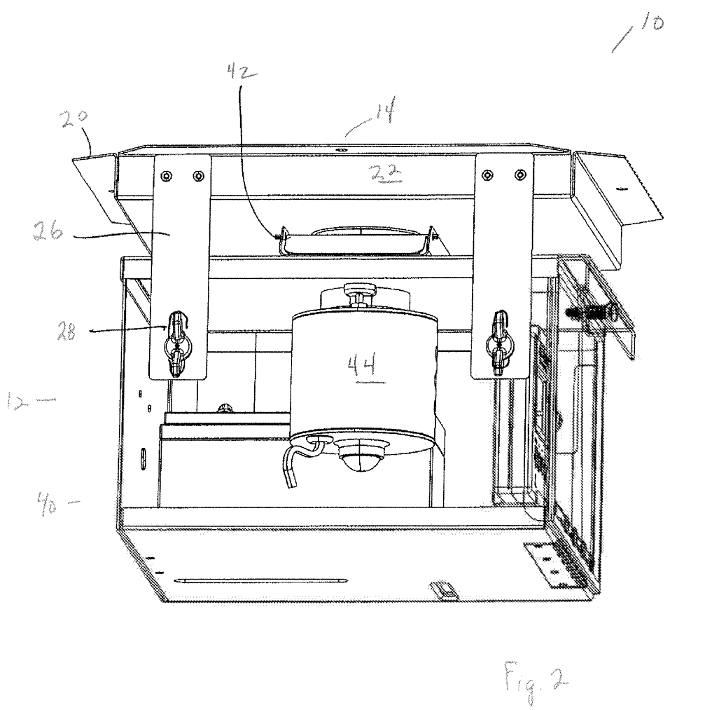

The illustrations show the general alignment of and dimensioned similarity of bases 24/36 with top wall 56 of control box housing 50. This alignment and the spacing or gap A (see FIG. 3) between these two surfaces are controlled by the placement of the legs and the slots in the legs, as well as the top side location of hub 62 on spinner plate 42 and generally absence of protrusions, fasteners or the like from top wall 56. The top side location of the hub allows the bottom of the spinner plate to be moved down close to the top wall 56 of the control base to minimize that gap. Moreover, the slots and vertical adjustment of the control box/spinner plate may be dimensioned to move close up to the base 24/36, so that, for example, the top edges 58A of side walls 58 of spinner plate 42 may be about 1/16 to about ¼ inch below tabular base 24/36 (preferably about ⅛ inch). This distance, about 1/16 to about ¼ inch, is typically also about the range that the spinner plate bottom wall 60 is placed above the top wall 56 of control box 40. The height of the spinner plate (side walls) is typically about 3/4 inch.

Applicant typically provides a gap A of between about ¾ inch and about 1½ inches, so as to minimize varmint access to the spinner and feed (preferably about 1 inch). Moreover, the mouths 65 are typically, at their closest, about 1 inch to 3 inches from the edge of top wall 56.

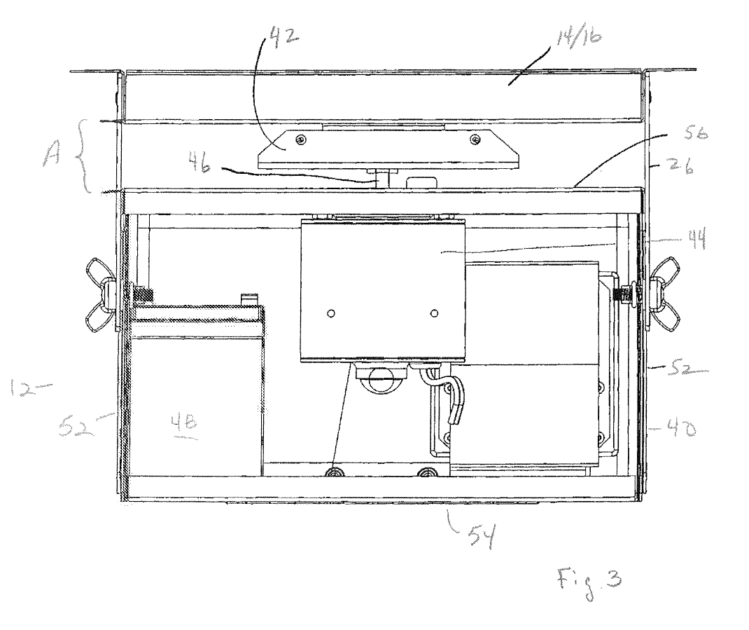

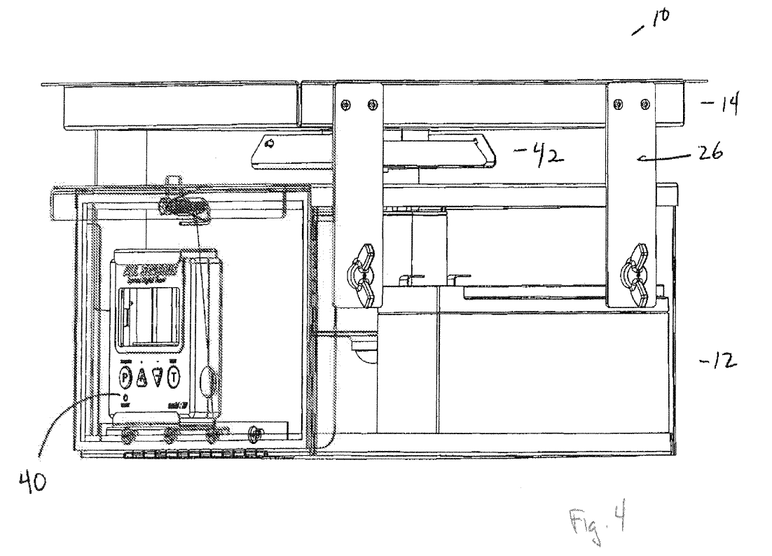

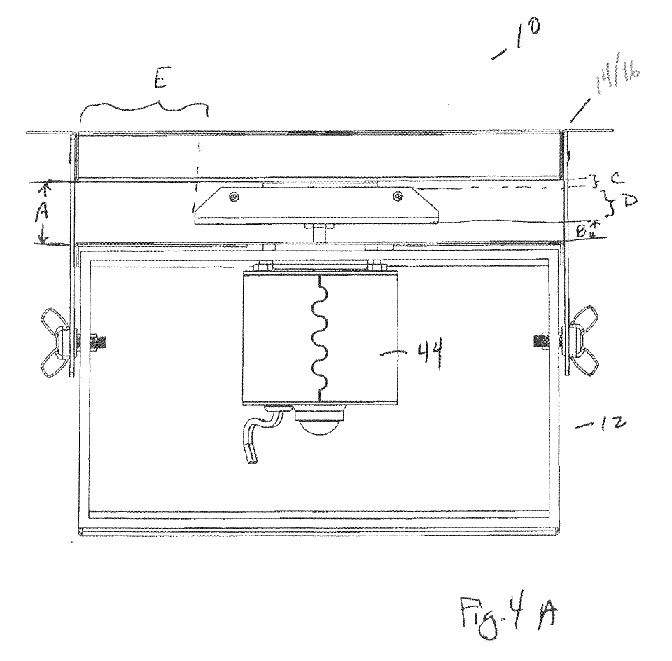

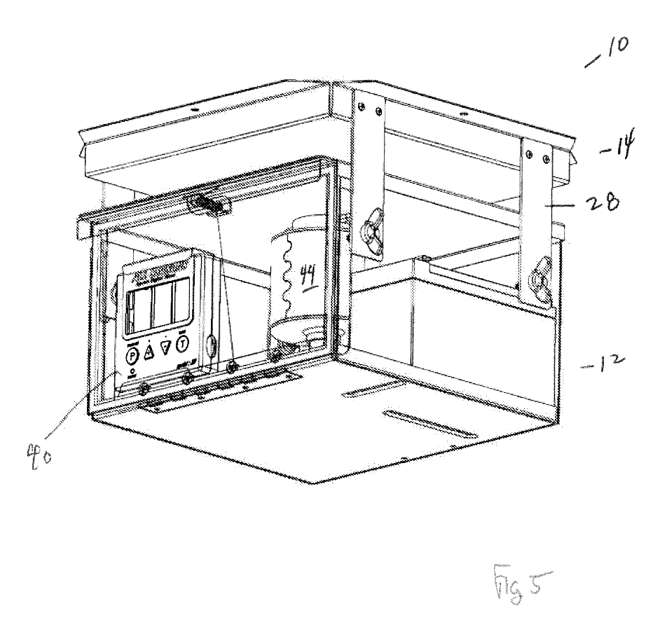

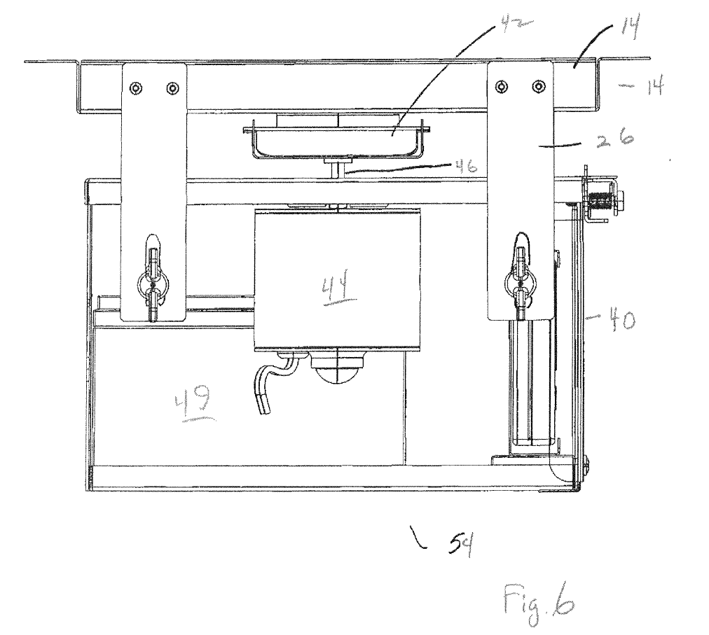

TABLE FOR DIMENSIONS (FIG. 4A)

| DIMENSION | RANGE | | PREFERRED | |
|---|---|---|---|---|
| A | ¾ to 1½ | inches | 1 | inch |
| B | 1/16 to ¼ | inch | ⅛ | inch |
| C | 1/16 to ¼ | inch | ⅛ | inch |
| D | ½ | | ½ | |
| E | 1-6 | inches | | |

The unit may be sold separately and retrofitted to existing hoppers, typically by providing fasteners or pop rivets to engage the flanges of plates 14/16 to the underside of existing hoppers. However, the term “hopper engagement plate” also includes OEM arrangements (not retrofitted) with the features of the base, etc. as set forth herein. That is to say, a hopper underside with the built-in tabular section adjacent the feed opening and the top wall of the control box engaged for placement as set forth herein is within the scope of these specifications.

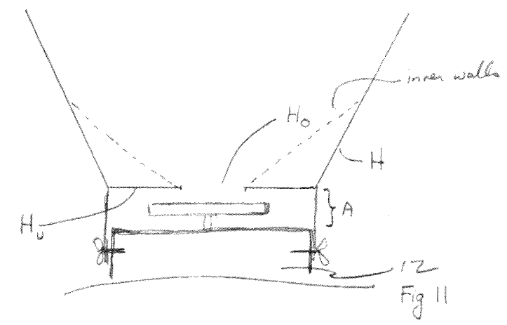

FIG. 11 illustrates an embodiment of Applicant's invention wherein the hopper engagement plate is built into the hopper, typically at the time the hopper is constructed. In the embodiment illustrated, the hopper engagement plate includes a base with a hopper opening HO on a hopper underside HU, which base is typically flat or tabular. The hopper, typically somewhere along the bottom side thereof, typically has a multiplicity of legs, here, for example, four (two to either side). These may be adjustable as set forth herein. The control box has spinner assembly 12.

Adjustments are typically provided, although the dimension A may be fixed, and are typically as set forth herein. These dimensions make it difficult for a varmint to reach in and dislodge feed from the hopper or feed on the spinner plate. In this embodiment, the hopper engagement plate is built into the lower walls of the hopper to provide all the structure and functional advantages of Applicant's embodiments as set forth herein.

Basically illustrated in FIG. 11 is a wildlife feeder comprising a hopper that has an engagement plate built in thereto. The engagement plate includes a tabular flat, generally horizontal base and has a feed opening typically centrally located in the flat, horizontal tabular base. The spinner of the control box is set, typically adjustably set, just below the feed opening of the horizontal base. The control box housing has a generally flat upper wall and typically engages the hopper on legs depending from the hopper. The legs may be adjustable as set forth herein so the position of the control box hopper, including distance A as illustrated in FIG. 11, may be controlled. Moreover, the aligning and spacing is, as set forth in these specifications are provided to substantially eliminate varmint access thereto. This means that the general dimensions set forth herein may be applied to a hopper engagement plate that is built into a hopper rather than a separate hopper engagement plate engaged to a preexisting hopper.

Although the foregoing specific details describe a preferred embodiment of this invention, persons reasonably skilled in the art will recognize that various changes may be made in the details of this invention without departing from the spirit and scope of the invention as defined in the appended claims. Therefore, it should be understood that this invention is not to be limited to the specific details shown and described herein.

1. An assembly for engaging a bottom wall of a hopper of a wildlife feeder, the bottom wall having a hopper feed dispensing opening, the hopper supported on a multiplicity of legs above the ground, the assembly comprising:
a motor with a drive shaft;
a spinner mounted near a removed end of the drive shaft;
a control box having a control box housing with an upper wall, the upper wall having an opening to allow the drive shaft to project substantially vertically therethrough; and
a hopper engagement plate adjacent the hopper feed dispensing opening, the hopper engagement plate having a base with a feed opening therethrough, the hopper engagement plate having walls with a multiplicity of legs depending therefrom wherein the feed opening of the base is located substantially below the hopper feed dispensing opening.

2. The assembly of claim 1, wherein the multiplicity of legs of the hopper engagement plate engage the control box to position the spinner therebetween and such that the base of the hopper engagement plate and the upper wall of the control box housing are between about ¾ and 1½ inches apart.

3. The assembly of claim 1, wherein the multiplicity of legs is four.

4. The assembly of claim 1, wherein the multiplicity of legs include engagement slots for adjusting the distance between the hopper engagement plate and the control box.

5. The assembly of claim 1, wherein the base of the hopper engagement plate is generally tabular.

6. The assembly of claim 1, wherein the base of the hopper engagement plate is generally tabular and wherein the upper wall of the control box housing is generally tabular.

7. The assembly of claim 1, wherein the base of the hopper engagement plate is generally tabular; wherein the upper wall of the control box housing is generally tabular; and wherein the base and the upper wall are aligned.

8. The assembly of claim 1, wherein the multiplicity of legs is four; and wherein the multiplicity of legs include engagement slots for adjusting the distance between the hopper engagement plate and the control box.

9. The assembly of claim 1, wherein the multiplicity of legs is four; wherein the multiplicity of legs include engagement slots for adjusting the distance between the hopper engagement plate and the control box; and wherein the base of the hopper engagement plate is generally tabular.

10. The assembly of claim 1, wherein the multiplicity of legs is four; wherein the multiplicity of legs include engagement slots for adjusting the distance between the hopper engagement plate and the control box; wherein the base of the hopper engagement plate is generally tabular; wherein the upper wall of the control box housing is generally tabular; and wherein the base and the upper wall are aligned.

11. The assembly of claim 1, wherein the spinner is located below the feed opening of the base of the hopper engagement plate.

12. The assembly of claim 11, wherein the multiplicity of legs is four.

13. The assembly of claim 11, wherein the base of the hopper engagement plate is generally tabular; and wherein the upper wall of the control box housing is generally tabular.

14. The assembly of claim 11, wherein the base of the hopper engagement plate is generally tabular; wherein the upper wall of the control box housing is generally tabular; and wherein the base and the upper wall are aligned.

15. The assembly of claim 11, wherein the multiplicity of legs is four; wherein the multiplicity of legs include engagement slots for adjusting the distance between the hopper engagement plate and the control box; wherein the base of the hopper engagement plate is generally tabular; wherein the upper wall of the control box housing is generally tabular; wherein the base of the hopper engagement plate is generally tabular and wherein the upper wall of the control box housing is generally tabular; and wherein the base and the upper wall are aligned.

16. The assembly of claim 10, wherein the multiplicity of legs of the hopper engagement plate engage the control box to position the spinner therebetween and such that the base of the hopper engagement plate and the upper wall of the control box housing are between about ¾ and 1½ inches apart.

17. The assembly of claim 1, wherein the multiplicity of legs of the hopper engagement plate engage the control box to position the spinner therebetween and such that the base of the hopper engagement plate and the upper wall of the control box housing are between about ¾ and 1½ inches apart; wherein the multiplicity of legs is four, wherein the multiplicity of legs include engagement slots, wherein the base of the hopper engagement plate is generally tabular; wherein the upper wall of the control box housing is generally tabular; wherein the base of the hopper engagement plate is generally tabular; wherein the upper wall of the control box housing is generally tabular; and wherein the base and the upper wall are aligned.

18. An assembly for engaging a bottom wall of a hopper of a wildlife feeder, the bottom wall having a hopper feed dispensing opening, the hopper supported on a multiplicity of legs above the ground, the assembly comprising:
a motor with a drive shaft;
a spinner mounted near a removed end of the drive shaft;
a control box having a control box housing with an upper wall, the upper wall having an opening to allow the drive shaft to project substantially vertically therethrough; and
a hopper engagement plate for engaging the bottom wall of the hopper adjacent the hopper feed dispensing opening, the hopper engagement plate having a base with a feed opening therethrough, the hopper engagement plate having walls with a multiplicity of legs depending therefrom wherein the feed opening of the base is located substantially below the hopper feed dispensing opening;
wherein the multiplicity of legs of the hopper engagement plate engage the control box to position the spinner therebetween and such that the base of the hopper engagement plate and the upper wall of the control box housing are between about ¾ and 1½ inches apart;
wherein the multiplicity of legs is four; and
wherein the multiplicity of legs include engagement slots for adjusting the distance between the hopper engagement plate and the control box.

19. A wildlife feeder comprising:
a hopper having an engagement plate, the engagement plate including a tabular, flat, generally horizontal base and having a feed opening therein;
a spinner;
a control box having a control box housing having a removed upper wall and a motor, the motor with a drive shaft, the spinner mounted at the end of the drive shaft and centered below the feed opening of the base;
wherein the upper wall of the control box is aligned with and spaced apart and below the base of the engagement plate so as to substantially eliminate varmint access thereto.
